(19) United States
(12) Patent Application Publication
(10) Pub. No.: US 2004/0098718 A1
(43) Pub. Date: May 20, 2004

(54) Task allocation method in multiprocessor system, task allocation program product, and multiprocessor system

(76) Inventors: Kenichiro Yoshii, Tokyo (JP); Hirokuni Yano, Tokyo (JP); Seiji Maeda, Kawasaki-shi (JP); Tatsunori Kanai, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/715,546

(22) Filed: Nov. 19, 2003

(30) Foreign Application Priority Data
Nov. 19, 2002 (JP) 2002-335632

(51) Int. Cl. G06F 9/00

(52) U.S. Cl. 718/100

(57) ABSTRACT

A task allocation method in a multiprocessor system having a first processor with a first instruction set and a second processor with a second instruction set. A task is allocated to either of the first processor or the second processor. The task corresponds to a program having an execution efficiency. The program includes a program module described by either of the first instruction set or the second instruction set. In the method, a task that corresponds to a program module described by the first instruction set is allocated to the first processor. It is determined whether or not the execution efficiency of the program is improved if a destination allocated for the task is changed from the first processor to the second processor. If the execution efficiency of the program is improved, the destination allocated for the task is changed to the second processor.

### CROSS-REFERENCE TO RELATED APPLICATIONS

This application is based upon and claims the benefit of priority from the prior Japanese Patent Application No. 2002-335632, filed Nov. 19, 2002, the entire contents of which are incorporated herein by reference.

### BACKGROUND OF THE INVENTION

1. Field of the Invention

The present invention relates to a task allocation method in a multiprocessor system having different kinds of processors with different instruction sets, a task allocation program product, and a multiprocessor system.

2. Description of the Related Art

A multiprocessor system is a computer system that executes one program with a plurality of processors (CPUs), as described, for example, in Chapter 9 of the Japanese translation of “Computer Organization and Design: The Hardware/Software Interface”, 2nd ed. Vol. 2, David A. Patterson, John L. Hennessy, translated by Mitsuaki Narita, Nikkei BP, ISBN 4-8222-8057-8.

The respective processors are connected by an inter-processor connection unit such as a bus or a crossbar switch. A shared memory and an I/O control unit are connected to the inter-processor connection unit. In many cases, each processor has a cache memory. There is known a multiprocessor system wherein a shared memory is not provided but each processor has a local memory.

There is a widely used method of developing a program to be executed on a multiprocessor system. In this method, a program is described on the basis of the dependency among tasks (hereinafter referred to as “inter-task dependency”). A task is an execution unit of a program that implements a set of processing. An inter-task dependency refers to either of, or both of, the transfer of data and transfer of control among tasks. Each task is provided with a program module necessary for actually executing the task on the processor. This program development method has a feature that a program can be reused in units of a program module of each task. Thereby, the efficiency of development of the program is enhanced, and resources of many excellent program modules that have previously been developed can be utilized.

When a program described on the basis of the inter-task dependency is to be executed on a multiprocessor system, a process is required to allocate tasks to the respective processors by determining which task is to be executed by which processor. This task allocation process is performed so as to achieve high execution efficiency. The “high execution efficiency” means, for example, that the execution time of the entire program is short, the process data amount per unit time is large, the load on each processor is small, and the data amount in inter-processor communications is small (or the number of times of inter-processor communications is small).

The processor (CPU) has its own specific instruction set, depending on the kind of the processor. The instruction set is a group of instructions that can be understood by the processor. Aside from an ordinary multiprocessor system comprising the same kind of processors each having the same instruction set, there is a multiprocessor system comprising different kinds of processors having different instruction sets (hereinafter referred to as “hetero-multiprocessor system”). The hetero-multiprocessor executes a program formed by combining, as tasks, program modules described by a plurality of instructions sets for different kinds of processors.

As a matter of course, in the hetero-multiprocessor system, like the ordinary multiprocessor system comprising the same kind of processors, tasks are allocated to the processors so as to achieve high program execution efficiency. However, even if the task allocation method used in the ordinary multiprocessor system is simply applied to the hetero-multiprocessor system, a sufficient program execution efficiency cannot be obtained.

In the normal multiprocessor system, an individual task is allocated to the processor having the same instruction set as is used for describing the program module of this task. If task allocation is performed in the hetero-multiprocessor system, using the task allocating method in the ordinary multiprocessor system as a standard for judgment, inter-processor communications will occur frequently due to the inter-task dependency, that is, due to the order of execution of tasks. Due to an overhead of such frequent inter-processor communications, a serious problem, that is, deterioration in program execution efficiency, occurs in the hetero-multiprocessor system.

The present invention is directed to a task allocation method in a multiprocessor system having different kinds of processors with different instruction sets, which can enhance program execution efficiency, and also to a task allocation program product and a multiprocessor system.

### BRIEF SUMMARY OF THE INVENTION

According to embodiments of the present invention, there is provided a task allocation method, in a multiprocessor system having a first processor with a first instruction set and a second processor with a second instruction set. A task is allocated to either of the first processor or the second processor. The task corresponds to a program having an execution efficiency. The program includes a program module described by either of the first instruction set or the second instruction set. In the method, a task that corresponds to a program module described by the first instruction set is allocated to the first processor. It is determined whether or not the execution efficiency of the program is improved if a destination allocated for the task is changed from the first processor to the second processor. If the execution efficiency of the program is improved, the destination is changed to the second processor.

### BRIEF DESCRIPTION OF THE SEVERAL VIEWS OF THE DRAWING

FIG. 1 is a block diagram showing a structure of a multiprocessor system according to embodiments of the present invention;

FIG. 2 shows a first example of implementation of a task allocation program;

FIG. 3 shows a second example of implementation of a task allocation program;

FIG. 4 shows a third example of implementation of a task allocation program;

FIG. 5 shows a fourth example of implementation of a task allocation program;

FIG. 6 shows an example of a program described on the basis of the dependency among tasks executed by the multiprocessor system;

FIG. 7A shows an example of the state of execution of a task;

FIG. 7B shows another example of the state of execution of a task;

FIG. 7C shows still another example of the state of execution of a task;

FIG. 8 is a block diagram showing a functional configuration of a task allocation system;

FIG. 9 is a block diagram showing a detailed structure of an optimization execution determination section 25 shown in FIG. 8;

FIG. 10 shows an example of a program described on the basis of the dependency among tasks, wherein the tasks are created based on program modules described by a plurality of different instruction sets;

FIG. 11 shows an example in which the program of FIG. 10 is allocated to processors, employing the instruction sets used for describing the program modules as a standard for determination of allocation;

FIG. 12 shows an example of an allocation scheme, wherein the allocation illustrated in FIG. 11 is regarded as “provisional allocation” and the provisional allocation destinations are properly changed to determine final allocation;

FIG. 13 is a flowchart illustrating an example of a task allocation process;

FIG. 14 is a flowchart illustrating an example of a provisional allocation process in the flowchart of FIG. 13;

FIG. 15 is a flowchart illustrating an example of a determination process in the flowchart of FIG. 13;

FIG. 16 shows an example of a pre-process of the determination process in FIG. 15;

FIG. 17 is a flowchart illustrating an example of an allocation destination processor changing process in FIG. 13;

FIG. 18 is a flowchart illustrating another example of the allocation destination processor changing process in FIG. 13;

FIG. 19 is a flowchart illustrating still another example of the allocation destination processor changing process shown in FIG. 13;

FIG. 20 is a flowchart illustrating another example of the task allocation process;

FIG. 21 is a flowchart illustrating still another example of the task allocation process;

FIG. 22A shows an example of a program module complex relating to a task allocation process according to embodiments of the present invention;

FIG. 22B shows another example of the program module complex;

FIG. 22C shows still another example of the program module complex;

FIG. 23 is a flowchart illustrating an example of the provisional allocation process;

FIG. 24 is a flowchart illustrating an example of the allocation destination processor changing process;

FIG. 25 is a flowchart illustrating another example of the allocation destination processor changing process; and

FIG. 26 is a flowchart illustrating still another example of the allocation destination processor changing process.

### DETAILED DESCRIPTION OF THE INVENTION

Embodiments consistent with the present invention include a hetero-multiprocessor. This multiprocessor includes a plurality of kinds of processors with different instruction sets. When a plurality of tasks are to be executed, the multiprocessor realizes selection and allocation change of tasks which should more properly be allocated to processors with different instruction sets. Thereby, the program execution efficiency of the entire system is enhanced.

There is provided a method of allocating a plurality of tasks to a multiple processors in a multiprocessor system. The tasks correspond to a program to be executed. The system includes at least a first processor with a first instruction set and a second processor with a second instruction set. Of the tasks, those described by the first instruction set are allocated to the first processor. At least one of the tasks allocated to the first processor is chosen as an object task, and it is determined whether the program execution efficiency is improved by changing the destination allocated for the object task to the second processor having the second instruction set. If the determination result indicates that the execution efficiency is improved, the allocation destination of the object task is changed to the second processor.

Specifically, the tasks executed by the multiprocessor system are created based on program modules each described by any one of the different instruction sets of the respective processors.

Embodiments consistent with the present invention provide a method and apparatus wherein tasks corresponding to a program are provisionally allocated to processors having the same instruction sets as those used in describing the program modules, and then it is determined whether the execution efficiency of the program is improved by changing the allocation destination processor. If the determination result indicates the necessity for the change of the allocation destination processor, the allocation destination of the object task is changed to implement final allocation.

Embodiments of the present invention will now be described with reference to the accompanying drawings.

(Entire Structure of Multiprocessor System)

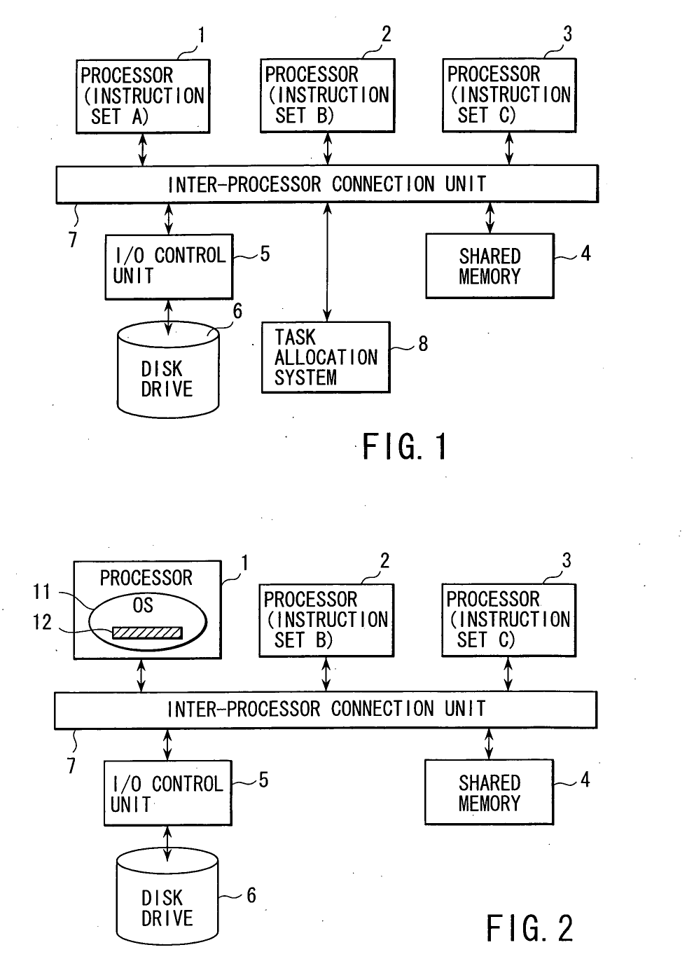

FIG. 1 shows an example of a basic structure of a multiprocessor system according to an embodiment of the present invention. This system is a so-called hetero-multiprocessor system. A plurality of processors 1 to 3 having instruction sets A, B and C, a shared memory 4 and an I/O control unit 5 are connected by an inter-processor connection unit 7 such as a bus or a crossbar switch. A large-capacity storage unit, such as a disk drive 6, is connected to the I/O control unit 5. A task allocation system 8, which is conceptually shown in FIG. 1, is connected to the inter-processor connection unit 7.

Although not shown in FIG. 1, the processors 1 to 3 may have caches or local memories. The multiprocessor system may not have the shared memory. FIG. 1 shows three processors 1 to 3, but the number of processors may be two, or more than three. It is not necessary that all the processors included in the hetero-multiprocessor system have mutually different instruction sets. Two or more of the processors may have the same instruction set. In short, the hetero-multiprocessor system may include at least two kinds of processors having different instruction sets.

Program modules necessary for actually executing tasks on the processors 1 to 3, which correspond to the program executed by the multiprocessor system, are stored in the disk drive 6 connected to the I/O control unit 5 or the shared memory 4. In the case of a multiprocessor system which does not have a shared memory but has local memories in processors, the program modules are stored in the local memories. In the program module, instructions necessary for executing the associated task are described by a specific instruction set.

(Examples of Implementation of Task Allocation System)

The task allocation system 8 functions to properly allocate tasks of a program, which is to be executed by the multiprocessor system, to the processors 1 to 3. Specifically, the task allocation system 8 is embodied as a program (hereinafter referred to as “task allocation program”). The task allocation program may be a dedicated program for task allocation, a part of an operating system, or a main program other than the operating system. FIGS. 2 to 5 show examples of implementation of the task allocation program.

In an example shown in FIG. 2, the task allocation program 12 is present as a part of an operating system (OS) 11 that runs on a specific processor 1. The task allocation program 12 controls a task allocation process for all the processors 1 to 3 including the processor 1 on which the operating system 11 including the task allocation program 12 runs.

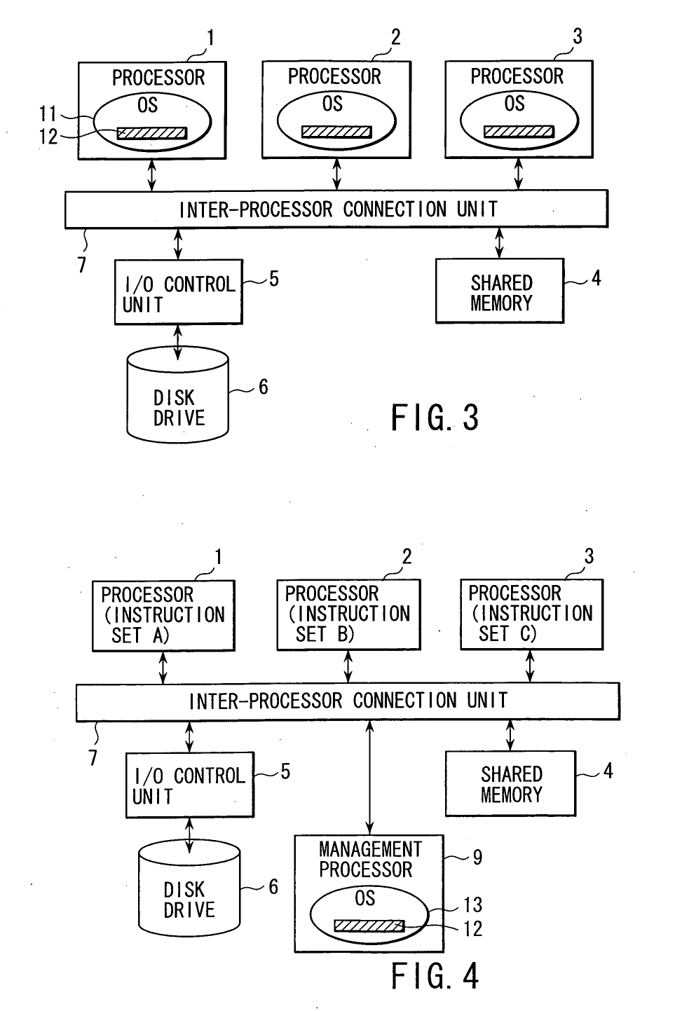

In an example depicted in FIG. 3, the task allocation program 12 is present as a part of each of the operating systems 11 running on all the processors 1 to 3 included in the multiprocessor system. The task allocation process in the system of FIG. 3 is executable in two modes. In one mode, the task allocation programs 12, which are parts of the operating systems 11 running on the processors 1 to 3, cooperate on a completely equal basis.

In the other mode of the task allocation process shown in FIG. 3, the task allocation program, which is a part of the operating system 11 running on a specific one of the processors 1 to 3, is used as a main program. The task allocation programs, which are parts of the operating systems 11 running on the other processors, are used as sub-programs. These main program and sub-programs cooperate to execute the task allocation process.

In an example shown in FIG. 4, a management processor 9 is provided in addition to the principal processors 1 to 3 in the multiprocessor system. The task allocation program 12 is present as a part of an operating system 13 running on the management processor 9. No task of the program executed by the multiprocessor system is allocated to the management processor 9.

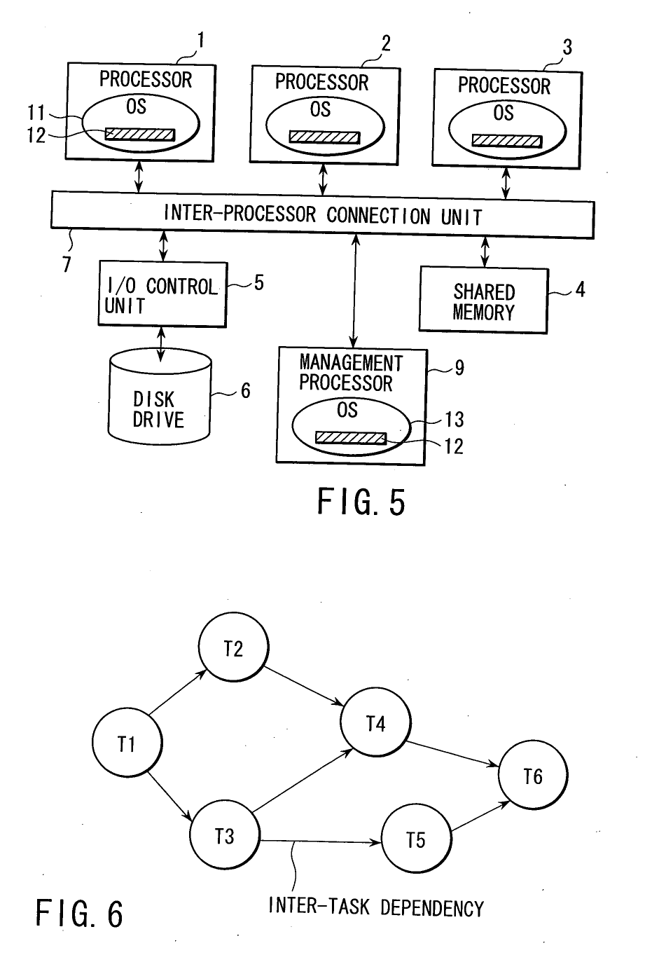

FIG. 5 shows an example in which the architectures shown in FIGS. 3 and 4 are combined. The task allocation program 12, which is a part of the operating system 13 running on the management processor 9, operates as a main program of the task allocation program. The task allocation programs 12, which are parts of the operating systems 11 running on the processors 1 to 3, operate as sub-programs of the task allocation program. The sub-programs cooperate with the main program to execute the task allocation process.

In the examples shown in FIGS. 2 to 5, as described above, the task allocation program is a part of the operating system. However, the task allocation program can similarly be implemented as a part of a main program or a dedicated program for task allocation.

(Program Executed by the Multiprocessor System)

As is shown in FIG. 6, a program executed by the multiprocessor system is described by a plurality of tasks T1 to T6 and the dependency among the tasks T1 to T6. As mentioned above, each of the tasks T1 to T6 is an execution unit of a program that implements a set of processing. The dependency among the tasks T1 to T6 refers to either of, or both of, the transfer of data and transfer of control among the tasks T1 to T6. In FIG. 6, the transfer of data or control from task to task is indicated by arrows. When program modules of tasks are executed, data is transferred among the tasks, as indicated by the arrows.

(Examples of Execution of Task of Program)

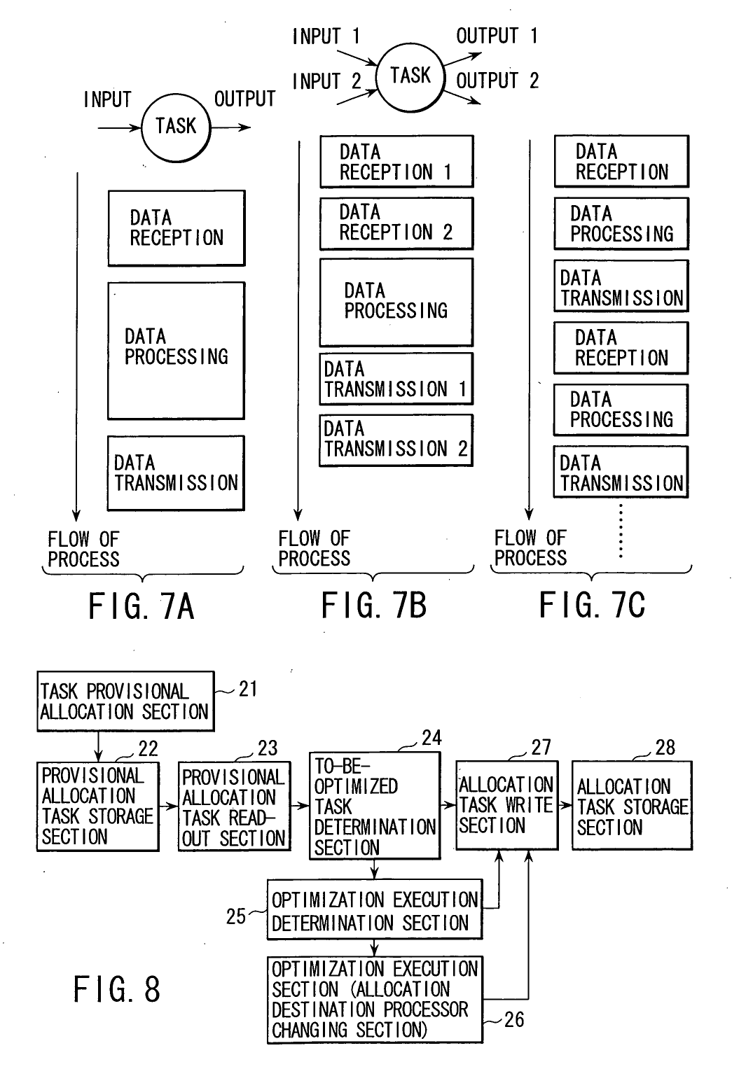

FIGS. 7A to 7C show examples of the state of execution of tasks.

An example shown in FIG. 7A relates to 1-input/1-output task execution. The task execution comprises three steps: receiving data necessary for processing from an input-side task, subjecting the data to the processing, and finally transmitting the processed data to an output-side task.

An example of FIG. 7B relates to 2-input/2-output task execution. The task execution comprises receiving data from all input-side tasks, processing the received data, and transmitting the processed data to output-side tasks.

In an example shown in FIG. 7C, unlike FIGS. 7A and 7B, input data is not received at a time. In the task execution in FIG. 7C, data is intermittently received from input-side tasks. For example, data received in a given unit time is processed, and the processed data is transmitted to an output-side task in succession.

The cost of the data reception/transmission among tasks during the task execution is relatively high, though it depends on configurations of the multiprocessor system.

In the multiprocessor system having the shared memory 4 as shown in FIG. 1, regardless of whether a task of transmitting data and a task of receiving data are allocated to the same processor or different processors, the data transmission is realized by data write to the shared memory 4, and the data reception is realized by data read-out from the shared memory 4. In general, the cost of write/read to/from the shared memory 4 is also high.

On the other hand, in the multiprocessor system wherein processors have caches, if the tasks of data transmission and data reception are allocated to the same processor, the data transmission/reception among the tasks is performed via the cache in the processor. Normally, the access to the cache is faster than the access to the shared memory. Thus, if attention is paid to the tasks, the transmission of processed data and the reception of data necessary for processing are realized by the data read/write from/to the cache, and the apparent cost of data transmission/reception is reduced. However, the content in the cache needs to be kept in consistent with the content in the memory and, in fact, data write to the shared memory occurs.

In the case where the task of data transmission and the task of data reception are allocated to different processors, the data transmission is realized by data write to the shared memory and the data reception is realized by data read-out from the shared memory, though the data transmission/reception mode may differ depending on the architecture of the caches. The data transmission/reception among the tasks is thus realized. The cost of the data transmission/reception via the shared memory in this case is also high.

In the multiprocessor system wherein the processors have local memories, if the tasks for data transmission and data reception are allocated to the same processor, the data transmission/reception among the tasks is performed using the local memories in the processors. Normally, the access to the local memory is faster than the access to the shared memory. However, in the case where the task for data transmission and the task for data reception are allocated to different processors, the inter-task data transmission/reception is realized by data transfer from the local memory of the processor, to which the transmission-side task is allocated, to the local memory in the processor, to which the reception-side task is allocated. Normally, the cost of the communication between the local memories is high, like the case of the access to the shared memory.

As stated above, in the multiprocessor system, the cost of inter-processor communication is high. It is thus necessary to allocate tasks to processors, giving full consideration to the inter-processor communication.

In the prior-art task allocation scheme, a task is allocated to the processor having the same instruction set as is used for the description of the program module necessary for executing the task. If this allocation method is applied to the hetero-multiprocessor system, inter-processor data communications will occur frequently and the program execution efficiency deteriorates.

In order to alleviate this problem, the status of “provisional allocation” is given to the conventional allocation scheme in which a task is allocated to a processor having the same instruction set as is used for describing the program module necessary for executing the task. After the completion of the “provisional allocation”, the allocation of tasks to the processors is changed and optimized to enhance the program execution efficiency.

(Details of Task Allocation System)

FIG. 8 shows an example of the structure of the task allocation system 8 shown in FIG. 1. As described above, the task allocation system 8 may be a dedicated task allocation program, a part of an operating system, or a main program other than the operating system. In FIG. 8, the functions of the task allocation system 8 are depicted in blocks for easier understanding.

In FIG. 8, a task provisional allocation section 21 performs the aforementioned “provisional allocation”. That is, the task provisional allocation section 21 allocates a task to the processor having the same instruction set as is used for describing the program module necessary for executing the task. Information relating to provisional allocation of each task is stored, for example, in the disk drive 6 shown in FIG. 1, or a provisional allocation task storage section 22, which is a part of the shared memory 4. The information relating to provisional allocation of each task is read out by a provisional allocation task read-out section 23.

The information read out by the provisional allocation task read-out section 23 is input to a to be-optimized task determination section 24. With respect to all tasks corresponding to each program to be executed by the multiprocessor system, the to-be-optimized task determination section 24 determines whether it is better to change allocation destinations by the optimization. With respect to a task that has been determined to be a to-be-optimized task, an optimization execution determination section 25 determines whether the allocation of the task to the processor should actually be changed by the optimization.

An optimization execution section 26 actually performs an allocation destination changing process for the task, for which the change of the allocation destination to the processor by the optimization has been determined. Regardless of whether the allocation destination has been changed or not, an allocation task write section 27 writes information on a final allocation result of all tasks, for example, into the disk drive 6 shown in FIG. 1 or an allocation task storage section 28, which is a part of the shared memory 4.

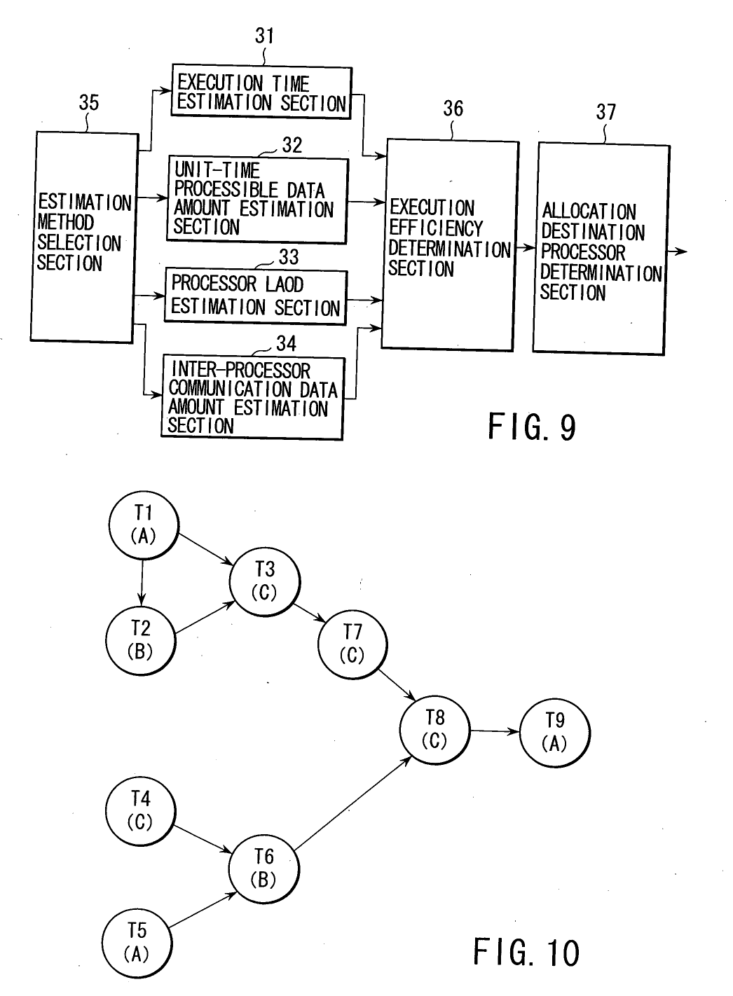

As is shown in FIG. 9, the optimization execution determination section 25 includes, as means for estimating program execution efficiency, e.g. an execution time estimation section 31, a unit-time processible data amount estimation section 32, a processor load estimation section 33 and an inter-processor communication data amount estimation section 34. An estimation method selection section 35 selects one or more of the estimation sections for determining execution efficiency.

The execution time estimation section 31 estimates task execution times in a case where the object task is allocated, without change, to a provisional allocation destination and in a case where the allocation destination is changed. The unit-time processible data amount estimation section 32 estimates a processible data amount per unit time of the program in cases where the object task is allocated, without change, to a provisional allocation destination and the allocation destination is changed. The processor load estimation section 33 estimates a load on the allocation-destination processor in the case where the object task allocation destination is changed. The inter-processor communication data amount estimation section 34 estimates an inter-processor communication data amount of the program in cases where the object task is allocated, without change, to a provisional allocation destination and the allocation destination is changed.

An execution efficiency determination section 36 determines the program execution efficiency on the basis of an estimation result of the estimation section(s) selected by the estimation method selection section 35. Specifically, the execution efficiency determination section 36 determines whether the program execution efficiency is enhanced by the change of the task allocation destination, on the basis of (a) whether the execution time estimated by the execution time estimation section 31 decreases by the change of the allocation destination, (b) whether the processible data amount estimated by the unit-time processible data amount estimation section 32 increases by the change of the allocation destination, or whether the estimated processible data amount increases beyond a predetermined threshold by the change of the allocation destination, (c) whether a load on the processor estimated by the processor load estimation section 33 becomes an overload, and (d) whether the inter-processor communication data amount estimated by the inter-processor communication data amount estimation section 34 decreases by the change of the allocation destination.

When the estimation method selection section 35 has selected a plurality of estimation sections, the execution efficiency determination section 36 comprehensively examines the estimation results of these estimation sections, and finally determines whether the execution efficiency is enhanced. Concrete methods of the execution efficiency determination are explained later in detail.

An allocation destination processor determination section 37 determines a new allocation destination processor for the task, with respect to which the execution efficiency determination section 36 has determined that “the program execution efficiency is enhanced by the change of the task allocation destination.” On the other hand, the provisional allocation destination processor is determined to be the final allocation destination processor for the task, with respect to which the execution efficiency determination section 36 has determined that “the program execution efficiency is not enhanced by the change of the task allocation destination.”

FIG. 10 shows an example of a program in which program modules described by a plurality of instruction sets for different processors are combined as tasks T1 to T9. The instruction sets, by which the program modules of tasks T1 to T9 are described, are designated by letters A, B and C in parentheses ( ). The program shown in FIG. 10 comprises tasks T1, T5 and T9 having program modules described by the instruction set A, tasks T2 and T6 having program modules described by the instruction set B, and tasks T3, T4, T7 and T8 having program modules described by the instruction set C.

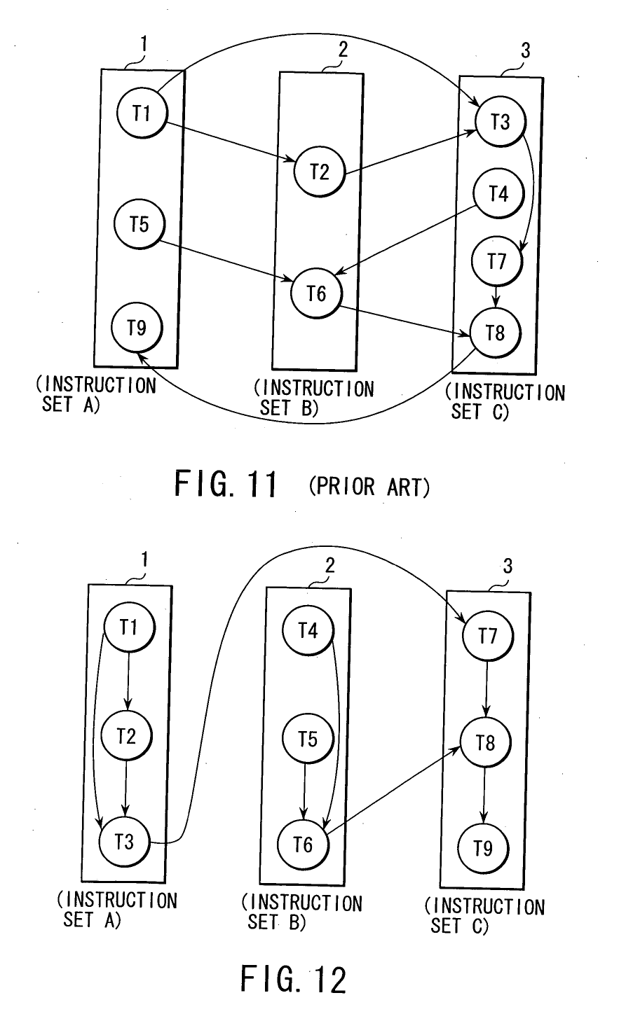

According to a conventional task allocation method, the tasks in the program shown in FIG. 10 are allocated to the processors having the instruction sets, by which the associated program modules are described, as shown in FIG. 11. Specifically, the tasks T1, T5 and T9 are allocated to the processor 1 having the instruction set A. The tasks T2 and T6 are allocated to the processor 2 having the instruction set B. The tasks T3, T4, T7 and T8 are allocated to the processor 3 having the instruction set C.

As mentioned above, the status of “provisional allocation” is given to the task allocation shown in FIG. 11. By the optimization after the provisional allocation, the allocation destination processors can be changed, for example, as shown in FIG. 12. Thereby, the number of times of inter-task data transmission/reception, which requires inter-processor communications, is greatly reduced from seven, as shown in FIG. 11, to two, as shown in FIG. 12. In short, an overhead due to inter-processor communications decreases, and the program execution efficiency is remarkably improved.

(Task Allocation Process Procedure 1)

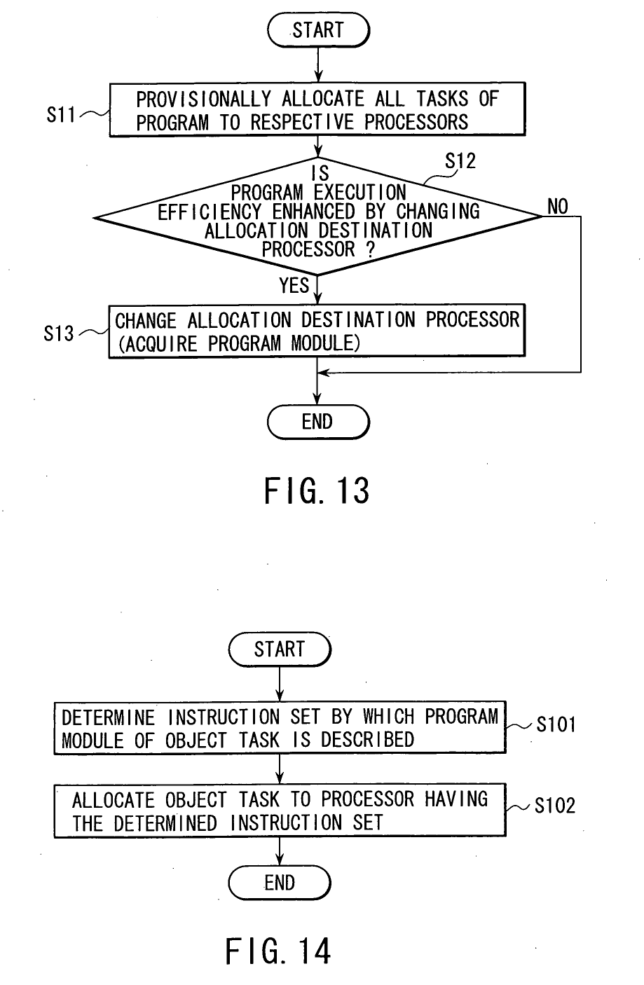

A task allocation process procedure will now be described with reference to flowcharts. FIG. 13 illustrates a basic flow of an example of the task allocation process. The procedure shown in FIG. 13 is referred to as task allocation process procedure 1.

The task provisional allocation section 21 (shown in FIG. 8) provisionally allocates all tasks of the program to the respective processors (step S11). The information relating to the provisional allocation of each task is retained in the provisional allocation task storage section 22 (shown in FIG. 8). The information relating to the provisional allocation is read out from the provisional allocation task storage section 22 by the provisional allocation task read-out section 23. The read-out information is delivered to the to-be-optimized task determination section 24.

The to-be-optimized task determination section 24 determines an object task (to-be-optimized task), from all the tasks of the program, which will possibly enhance the program execution efficiency by the change of the allocation destination processor. With respect to the determined object task, the optimization execution determination section 25 determines whether the program execution efficiency is enhanced by the change of the allocation destination processor (step S12).

As regards the task which has been determined in step S12 not to enhance the program execution efficiency by the change of the allocation destination processor, the present process is finished by setting the provisional allocation destination processor, obtained in step S11, to be the final allocation destination processor. On the other hand, for the task which has been determined to enhance the program execution efficiency by the change of the allocation destination processor, a new allocation destination processor is determined.

Next, the allocation destination processor of the task, which has been determined to enhance the program execution efficiency by the change of the allocation destination processor, is changed to the determined new allocation destination processor (step S13). Specifically, to change the allocation destination processor means to acquire the program module described by the instruction set possessed by the new allocation destination processor for the object task.

Following the completion of the process illustrated in FIG. 13, all tasks of the program are allocated to proper processors. Thereby, the multiprocessor system can efficiently execute the present program.

The process comprising steps S11 to S13 in FIG. 13 is described in detail.

FIG. 14 shows the details of the processing of step S11 in FIG. 13. The instruction set, by which the program module of the object task to be allocated is described, is determined (step S101). The object task is allocated to the processor having the determined instruction set (step S102). Referring to the program shown in FIG. 10 by way of example, the tasks of the program shown in FIG. 10 are allocated to the processors, as shown in FIG. 11, in this provisional allocation step.

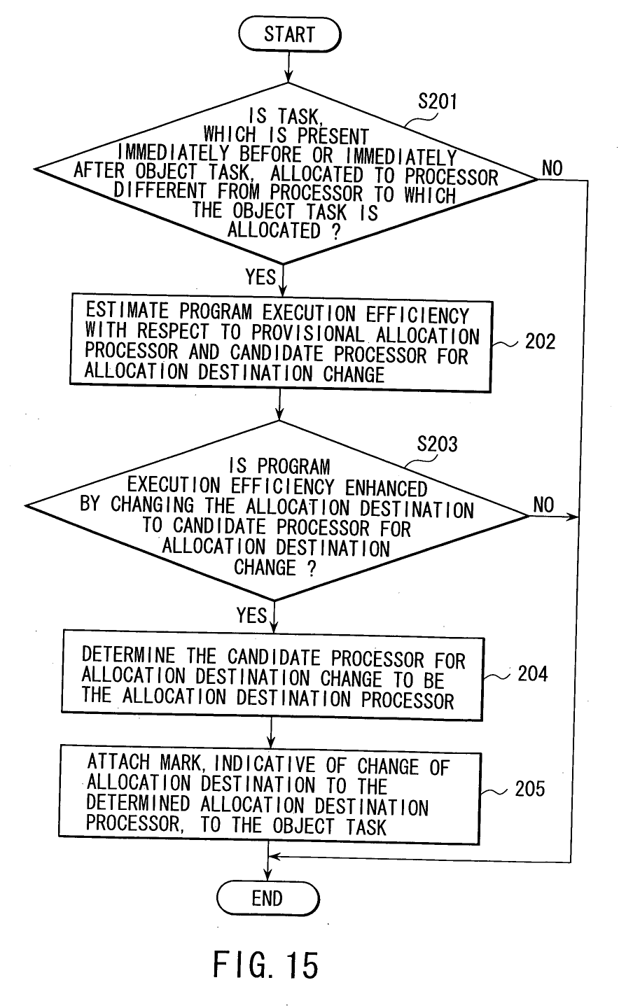

FIG. 15 is a flowchart illustrating the details of the processing of step S12 in FIG. 13. FIG. 15 refers to the process for one object task, but in fact all the tasks are subjected to the same process. This process can be applied twice or more to the same object task. For example, it is possible to perform the process of FIG. 15 for all the tasks, perform allocation change for some tasks by optimization, and then perform the same process for the resultant tasks once again. Thereby, a better optimization result may be obtained.

The information relating to the task provisional allocation, which is read out by the provisional allocation task read-out section 23, is delivered to the to-be-optimized task determination section 24. The to-be-optimized task determination section 24 determines whether a task, which is present immediately before or immediately after the object task of interest subjected to the provisional allocation in step S11, is allocated to a processor having an instruction set different from the instruction set of the processor to which the object task is provisionally allocated (step S201).

In the program of FIG. 10, for instance, there is no task immediately before each of tasks T1, T2, T4 and T5. In this case, a pseudo task is defined as “immediately preceding task.” The pseudo task is, for example, a task, with respect to which an estimated execution time is “0”, data to be transmitted to the object task is “0” and there is no influence on the load of the processor. Similarly, an “immediately following task” is defined for the object task, such as task T9 in FIG. 10, immediately after which there is no task.

If “YES” in step S201, the information relating to the object task, which is the to-be-optimized task, is delivered to the to-be-optimized task determination section 24, and a process in step S202 is performed. On the other hand, if “NO” in step S201, that is, if tasks immediately before and after the object task are provisionally allocated to the same processor as the object task, there is no need to change the allocation destination processor for the object task. In other words, even if the allocation destination processor is changed, the program execution efficiency is not improved. Accordingly, this determination result is sent to the allocation task write section 27, and the information relating to the provisional allocation task is written in the allocation task storage section 28. The process is thus finished.

In step S202, the optimization execution determination section 25 estimates the program execution efficiency in two cases, i.e. a case where the task determined to be the to-be-optimized task in step S201 is allocated, without change, to the processor to which task is already provisionally allocated, and a case where the task determined to be the to-be-optimized task in step S201 is allocated to a candidate processor for allocation destination change. The candidate processor for allocation destination change, in this context, is any one of the processors that are different from the processor, to which the to-be-optimized task of interest is provisionally allocated, and is any one of the processors to which the tasks immediately before and after the to-be-optimized task of interest are provisionally allocated.

Subsequently, the optimization execution determination section 25 determines whether the program execution efficiency is enhanced by changing the allocation destination processor of the to-be-optimized object task to the candidate processor for allocation destination change (step S203). If “YES” in step S203, the optimization execution determination section 25 determines that the candidate processor for allocation destination change is the final allocation destination processor (step S204) and attaches a mark, which indicates that the allocation destination processor is to be changed to the determined allocation destination processor, to the to-be-optimized object task (step S205). Thus, the process is finished. If “NO” in step S203, the process is finished without further processing.

(Grouping of Tasks)

It is possible that the program is not such a simple one as shown in FIG. 10. In the case of a large-scale program with many tasks, a program with a complex inter-task dependency or a program with many tasks and with a complex inter-task dependency, it is likely that the processing in the to-be-optimized task determination section 24 and optimization execution determination section 25 becomes complex.

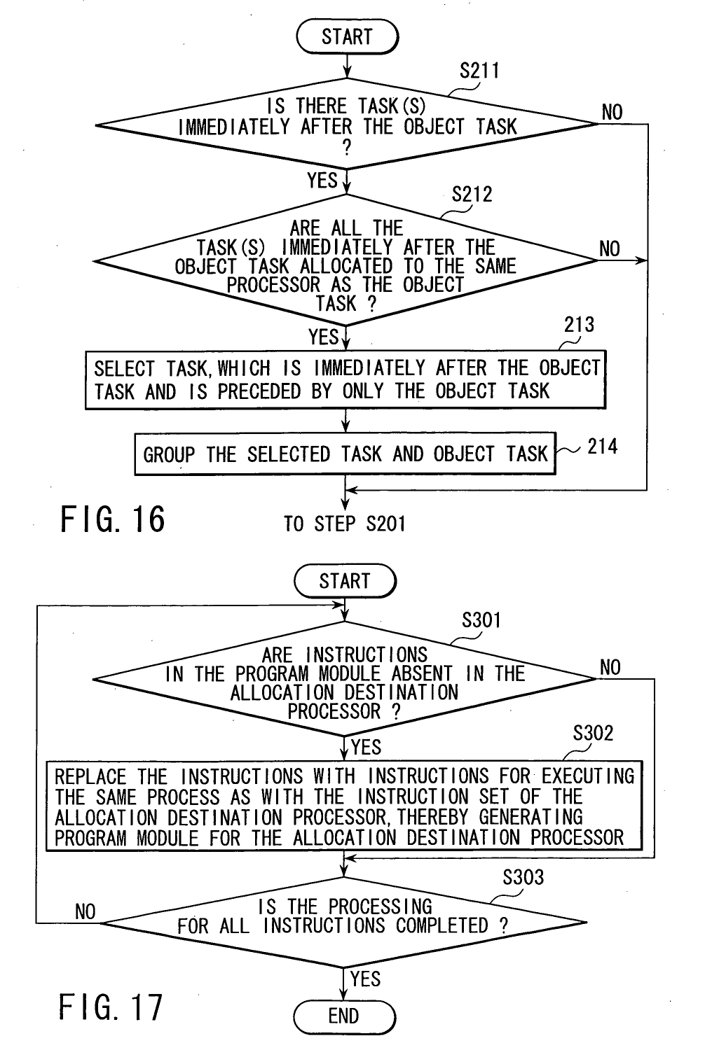

FIG. 16 illustrates a process for grouping tasks of the program, thereby simplifying the task allocation process for the complex program. This process is provided, for example, as a pre-process of step S201 in FIG. 15. The grouping of tasks can simplify the task provisional allocation, and accordingly simplify the process shown in FIG. 15. FIG. 16 shows the process for one task by way of example, but in fact the same process is performed for all the tasks.

The flow of the process in FIG. 16 is described. To start with, it is determined whether there is a task(s) immediately after the object task of interest (step S211). If “YES” in step S211, it is determined whether all the task(s) immediately after the object task are allocated to the same processor as the object task (step S212).

If “YES” in step S212, the task, which is immediately after the object task and is preceded by only the object task, is selected (step S213). The selected task and the object task are grouped (step S214), and the group is handled as a single object task. The group is delivered to step S201 in FIG. 15. By this grouping, the task allocation process can easily be performed even for a complex program.

(Optimization Execution Determination)

Next, the process of determination step S12 in FIG. 13, in particular, the process in steps S202 and S203 in FIG. 15, is described. The optimization execution determination section 25 (shown in FIG. 8), the structure of which is shown in detail in FIG. 9, performs the process by using singly or in combination the following execution efficiency determination standards.

[Execution Efficiency Determination Standard 1]

It is determined whether the program execution time (the time needed for executing tasks) is decreased by the change of the allocation destination processor.

The time needed for executing tasks can be estimated from the instruction sequence described in the program module necessary for task execution. Similarly, the time needed for executing tasks in the candidate processor for allocation destination change can be estimated.

According to the execution efficiency determination standard 1, if the estimated execution time needed for executing the object task, which is allocated to the candidate processor for allocation destination change, is shorter than the estimated execution time needed for executing the object task which is allocated, without change, to the provisional allocation processor, the object task is determined to be the to-be-optimized task, that is, the task for which the allocation destination processor should be changed by optimization.

It is possible that the estimated execution time needed for executing the object task in a plurality of candidate processors for allocation destination change is shorter than the estimated execution time needed for executing the object task in the provisional allocation processor. In this case, the processor with a shortest estimated execution time may be chosen as the allocation change destination processor. Alternatively, according to the execution efficiency determination standard 1, a plurality of processors may be chosen as candidate processors for allocation destination change, and then the final allocation change destination processor may be determined on the basis of another execution efficiency determination standard.

[Execution Efficiency Determination Standard 2]

It is determined whether the data amount processible by the task within a unit time is increased by the change of the allocation destination processor.

The data amount processible by the task within the unit time means a data amount that is receivable by the task from a preceding task within the unit time. The data amount receivable from the preceding task within the unit time by the inter-task communication is affected by whether the object task of interest and each preceding task are provisionally allocated to the same processor or to different processors. The reason is that communication between different processors is very high in cost than communication within the same processor.

According to the execution efficiency determination standard 2, the data amount receivable within the unit time by inter-task communications with all preceding tasks is estimated in two cases, i.e. a case where the object task is allocated, without change, to the provisional allocation destination processor, and a case where the object task is allocated to each candidate processor for allocation destination change.

If the data amount receivable within the unit time in any one of candidate processors for allocation destination change is larger than the data amount receivable within the unit time in the current provisional allocation destination processor, it is determined that the allocation destination processor for the object task of interest should be changed to the candidate processor for allocation destination change.

It is possible that the data amount receivable within the unit time by the object task of interest, which is allocated to a plurality of candidate processors for allocation destination change, is larger than the data amount receivable within the unit time by the object task of interest, which is allocated, without change, to the current provisional allocation processor. In such a case, a processor with a largest data amount receivable within the unit time by the object task is chosen as the processor for allocation destination change.

In the execution efficiency determination standard 2, the following method is adoptable. That is, a plurality of processors are chosen as candidate processors for allocation destination change, taking into account a case where, for example, the data amount receivable within the unit time by the object task in a plurality of candidate processors for allocation destination change is the same, and is larger than the data amount receivable within the unit time by the object task in the provisional allocation processor. Then, the final allocation destination processor is chosen on the basis of another execution efficiency determination standard.

[Execution Efficiency Determination Standard 3]

It is determined whether the increment of the data amount processible by the task within a unit time, between the case where the allocation destination processor is changed and the case where the allocation destination processor is not changed, is larger than a preset threshold.

The execution efficiency determination standard 3 is basically the same as the execution efficiency determination standard 2. In the determination standard 3, a threshold is used when the data amount receivable within the unit time by the object task of interest, which is allocated to the provisional allocation processor, is compared with the data amount receivable within the unit time by the object task of interest, which is allocated to the candidate processor for allocation destination change. Specifically, a static threshold preset before the start of selection or a dynamic threshold dynamically set during selection is adopted with respect to the data amount receivable within the unit time.

In the case where the data amount receivable within the unit time by the object task of interest, which is allocated to the candidate processor for allocation destination change, is larger than the data amount receivable within the unit time by the object task of interest, which is allocated to the provisional allocation processor, and is also larger than the threshold, it is determined that the allocation destination processor for the object task should be changed to the candidate processor for allocation destination change.

[Execution Efficiency Determination Standard 4]

It is determined whether a load on the processor for allocation destination change becomes an overload due to the change of the allocation destination processor.

Even where the allocation destination processor is changed from the provisional allocation processor, if an overload occurs in the processor for allocation destination change, the execution efficiency of the entire program is not improved.

The load on all the processors, in the case where the task of interest is allocated, with no change, to the provisional allocation processor, is estimated. In addition, the load on all the processors, in the case where the task of interest is allocated to any one of the candidate processors for allocation destination change, is estimated. If the allocation destination is changed and no overload occurs in the candidate processor for allocation destination change, it is determined that the allocation destination processor should be changed by optimization.

It is possible that there are a plurality of candidate processors for allocation destination change and no overload on the processors occurs even if the allocation destination is changed to any one of the candidate processors. In such a case, the following method may be adopted. That is, a candidate processor for allocation destination change, which causes a least load variation, is chosen. Alternatively, a candidate processor for allocation destination change, which causes a least load variation even if the allocation destination of the object task of interest is changed, is chosen. Moreover, in the execution efficiency determination standard 4, a plurality of processors may be chosen as candidate processors for allocation destination change, and the final allocation destination processor may be chosen on the basis of another execution efficiency determination standard.

[Execution Efficiency Determination Standard 5]

It is determined whether the inter-processor communication data amount of the entire program is reduced by the change of the allocation destination processor.

The key in the improvement of program execution efficiency in the multiprocessor system is the inter-processor communication data amount. Paying attention to this point, a determination standard is set as to whether the amount of data transferred between processors in the entire program is reduced when the object task is allocated, without change, to the provisional allocation processor and when the object task is allocated to the candidate processor for allocation destination change.

Specifically, the amount of data transferred by inter-processor communication in the entire program is estimated in a case where the allocation destination processor of the object task of interest is unchanged and in a case where the allocation destination processor of the object task is changed to any one of the candidate processors for allocation destination change. If the amount of data transferred by inter-processor communication in the entire program is reduced by changing the allocation destination processor of the object task to any one of the candidate processors for allocation destination change, it is determined that the allocation destination processor for the object task should be changed to the candidate processor for allocation destination change.

It is possible that the estimated amount of data transferred by inter-processor communication in the entire program in the case where the allocation destination of the object task is changed to a plurality of candidate processors for allocation destination change is less than the estimated amount of data transferred by inter-processor communication in the entire program in the case where the object task is allocated, with no change, to the provisional allocation processor. In such a case, a candidate processor for allocation destination change, which requires a least amount of data transferred by inter-processor communication in the entire program, is chosen as the allocation change destination processor. Alternatively, in the execution efficiency determination standard 5, a plurality of processors may be chosen as candidate processors for allocation destination change, and the final allocation destination processor may be chosen on the basis of another execution efficiency determination standard.

[Execution Efficiency Determination Standard 6]

It is determined whether the inter-processor communication data amount of the entire program in the unit time is reduced by the change of the allocation destination processor.

The execution efficiency determination standard 6 is basically the same as the execution efficiency determination standard 5. In the determination standard 6, the inter-processor transfer data amount in the unit time is estimated in a case where the object task of interest is allocated, without change, to the provisional allocation processor and in a case where the allocation destination processor of the object task is changed to any one of the candidate processors for allocation destination change. If the amount of data transferred by inter-processor communication in the unit time in the entire program in the case where the allocation destination processor of the object task is changed to any one of the candidate processors for allocation destination change is less than the amount of data transferred by inter-processor communication in the unit time in the entire program in the case where the object task is allocated, without change, to the provisional allocation processor, it is determined that the allocation destination processor for the object task should be changed to the candidate processor for allocation destination change.

(Examples of Task Allocation Process)

The above-described task allocation process procedures are explained referring to examples of specific programs.

In the description below, the procedures for optimizing the allocation destinations of tasks T1 to T9 of the program shown in FIG. 10, which are provisionally allocated as shown in FIG. 11, are explained in detail. The program shown in FIG. 10 comprises tasks T1, T5 and T9 having program modules described by the instruction set A, tasks T2 and T6 having program modules described by the instruction set B, and tasks T3, T4, T7 and T8 having program modules described by the instruction set C.

In the provisional allocation (FIG. 11) of tasks of the program shown in FIG. 10, the tasks T1, T5 and T9 are allocated to the processor 1 having the instruction set A, the tasks T2 and T6 are allocated to the processor 2 having the instruction set B, and the tasks T3, T4, T7 and T8 are allocated to the processor 3 having the instruction set C.

In the examples of the task allocation process described below, only the execution efficiency determination standards 1 and 5 are used in determining whether the allocation destination processor is to be changed, and in determining which processor is chosen as the allocation destination processor. Assume that a higher priority is given to the execution efficiency determination standard 5 than to the execution efficiency determination standard 1. These assumptions appear to be reasonable since it would be difficult to prepare all the above-described execution efficiency determination standards 1 to 6 due to constraints on system configurations, etc. in the actual multiprocessor system.

[Optimization of Allocation Destination of Task T1]

<Step 1-1> Task T1 is read out.

<Step 1-2> Since only a pseudo task is present immediately before task 1, the immediately preceding task can be ignored.

<Step 1-3> Tasks T2 and T3 are present immediately after task T1, and tasks T2 and T3 are provisionally allocated to the processors 2 and 3 different from the processor 1 to which task 1 is provisionally allocated. It is thus determined whether the allocation destination of task T1 is to be changed.

<Step 1-4> It is estimated whether the inter-processor communication data amount of the entire program is decreased by changing the allocation destination of task T1 from the processor 1 to processor 2, 3.

<Step 1-5> An estimated required execution time in a case where task T1 is executed, without change, by the processor 1, and an estimated required execution time in a case where task T1 is executed by the candidate processor 2, 3 for allocation destination change, are calculated.

<Step 1-6> Assume that the result in step 1-4 shows that there is no variation in inter-processor communication data amount of the program before and after the change of the allocation destination, and also assume that the result in step 1-5 shows that the estimated required execution time is shorter in the case where task T1 is executed on the processor 1.

<Step 1-7> Based on the result in step 1-6, it is determined that the allocation destination processor for task T1 is not changed.

[Optimization of Allocation Destination of Task T2]

<Step 2-1> Task T2 is read out.

<Step 2-2> Task T1 is present immediately before task 2.

<Step 2-3> Task T3 is present immediately after task T2, and tasks T1 and T3 are provisionally allocated to the processors 1 and 3 different from the processor 2 to which task 2 is provisionally allocated. It is thus determined whether the allocation destination of task T2 is to be changed.

<Step 2-4> It is estimated whether the inter-processor communication data amount of the entire program is decreased by changing the allocation destination of task T2 from the processor 2 to processor 1, 3.

<Step 2-5> An estimated required execution time in a case where task T2 is executed, without change, by the processor 2, and an estimated required execution time in a case where task T2 is executed by the candidate processor 1, 3 for allocation destination change, are calculated.

<Step 2-6> Assume that the result in step 2-4 shows that there is no variation in inter-processor communication data amount of the program before and after the change of the allocation destination, and also assume that the result in step 2-5 shows that the estimated required execution time is shorter in the case where task T2 is executed on the processor 1.

<Step 2-7> Based on the result in step 2-6, it is determined that the allocation destination processor for task T2 is changed to the processor 1.

[Optimization of Allocation Destination of Task T3]

<Step 3-1> Task T3 is read out.

<Step 3-2> Tasks T1 and T2 are present immediately before task T3.

<Step 3-3> Task T7 is present immediately after task T3, and tasks T1 and T2 are allocated to the processor 1 different from the processor 3 to which task T3 is provisionally allocated. Task T7 is provisionally allocated to the processor 3. Since tasks T1 and T2 are provisionally allocated to the processor 1, it is thus determined whether the allocation destination of task T3 is to be changed.

<Step 3-4> It is estimated whether the inter-processor communication data amount of the entire program is decreased by changing the allocation destination of task T3 to the processor 1.

<Step 3-5> An estimated required execution time in a case where task T3 is executed, without change, by the processor 3, and an estimated required execution time in a case where task T3 is executed by the candidate processor 1 for allocation destination change, are calculated.

<Step 3-6> Assume that the result in step 3-4 shows that the inter-processor communication data amount of the entire program is decreased by changing the allocation destination of task T3 to the processor 1, because tasks T1 and T2 are already allocated to the processor 1. In addition, assume that the result in step 3-5 shows that the estimated required execution time is substantially the same even in the case where task T3 is executed on the processor 1.

<Step 3-7> Based on the result in step 3-6, it is determined that the allocation destination processor for task T3 is changed to the processor 1.

[Optimization of Allocation Destination of Task T4]

<Step 4-1> Task T4 is read out.

<Step 4-2> Since only a pseudo task is present immediately before task 4, the immediately preceding task can be ignored.

<Step 4-3> Task T6 is present immediately after task T4, and task T6 is provisionally allocated to the processor 2 different from the processor 3 to which task 4 is provisionally allocated. It is thus determined whether the allocation destination of task T4 is to be changed.

<Step 4-4> It is estimated whether the inter-processor communication data amount of the entire program is decreased by changing the allocation destination of task T4 to the processor 2.

<Step 4-5> An estimated required execution time in a case where task T4 is executed, without change, by the processor 3, and an estimated required execution time in a case where task T4 is executed by the candidate processor 2 for allocation destination change, are calculated.

<Step 4-6> Assume that the result in step 4-4 shows that the inter-processor communication data amount of the entire program is decreased by changing the allocation destination of task T4 to the processor 2. In addition, assume that the result in step 4-5 shows that the estimated required execution time is substantially the same even in the case where task T4 is executed on the processor 2.

<Step 4-7> Based on the result in step 4-6, it is determined that the allocation destination processor for task T4 is changed to the processor 2.

[Optimization of Allocation Destination of Task T5]

<Step 5-1> Task T5 is read out.

<Step 5-2> Since only a pseudo task is present immediately before task 5, the immediately preceding task can be ignored.

<Step 5-3> Task T6 is present immediately after task T5, and task T6 is provisionally allocated to the processor 2 different from the processor 1 to which task 5 is provisionally allocated. It is then determined whether the allocation destination of task T5 is to be changed.

<Step 5-4> It is estimated whether the inter-processor communication data amount of the entire program is decreased by changing the allocation destination of task T5 to the processor 2.

<Step 5-5> An estimated required execution time in a case where task T5 is executed, without change, by the processor 1, and an estimated execution time in a case where task T5 is executed by the candidate processor 2 for allocation destination change, are calculated.

<Step 5-6> Assume that the result in step 5-4 shows that the inter-processor communication data amount of the entire program is decreased by changing the allocation destination of task T5 to the processor 2. Also assume that the result in step 5-5 shows that the estimated required execution time increases if task T5 is executed on the processor 2.

<Step 5-7> Based on the result in step 5-6 and the priority preset before the start of the process, it is determined that the allocation destination processor for task T5 is changed to the processor 2.

[Optimization of Allocation Destination of Task T6]

<Step 6-1> Task T6 is read out.

<Step 6-2> Tasks T4 and T5 are present immediately before task 6. Since both tasks T4 and T5 are allocated to the same processor 3 as task T6, these tasks can be ignored.

<Step 6-3> Task T8 is present immediately after task T6, and task T8 is provisionally allocated to the processor 3 different from the processor to which task 6 is provisionally allocated. It is thus determined whether the allocation destination of task T6 is to be changed.

<Step 6-4> It is estimated whether the inter-processor communication data amount of the entire program is decreased by changing the allocation destination of task T6 to the processor 3.

<Step 6-5> An estimated required execution time in a case where task T6 is executed, without change, by the processor 2, and an estimated execution time in a case where task T6 is executed by the candidate processor 3 for allocation destination change, are calculated.

<Step 6-6> Assume that the result in step 6-4 shows that the inter-processor communication data amount of the entire program increases if the allocation destination of task T6 is changed to the processor 3. In addition, assume that the result in step 6-5 shows that the estimated required execution time increases if task T6 is executed on the processor 3.

<Step 6-7> Based on the result in step 6-6, it is determined that the allocation destination processor for task T6 is not changed.

[Optimization of Allocation Destination of Task T7]

<Step 1-1> Task T7 is read out.

<Step 7-2> Task T3 is present immediately before task T7. Task T3 is allocated to the processor different from the processor 3 to which task T7 is allocated.

<Step 7-3> Task T8 is present immediately after task T7, and task T8 is allocated to the same processor 3 as task T7. However, since task T3 immediately before task T7 is allocated to the processor 1 different from the processor 3 to which task T7 is allocated, it is determined whether the allocation destination of task T7 is to be changed.

<Step 7-4> It is estimated whether the inter-processor communication data amount of the entire program is decreased by changing the allocation destination of task T7 to the processor 1.

<Step 7-5> An estimated required execution time in a case where task T7 is executed, without change, by the processor 3, and an estimated required execution time in a case where task T7 is executed by the candidate processor 1 for allocation destination change, are calculated.

<Step 7-6> Assume that the result in step 7-4 shows that the inter-processor communication data amount of the entire program increases if the allocation destination of task T7 is changed to the processor 1. In addition, assume that the result in step 7-5 shows that the estimated required execution time increases if task T7 is executed on the processor 1.

<Step 7-7> Based on the result in step 7-6, it is determined that the allocation destination processor for task T7 is not changed.

[Optimization of Allocation Destination of Task T8]

<Step 8-1> Task T8 is read out.

<Step 8-2> Tasks T6 and T7 are present immediately before task T8. Task T6 is allocated to the processor 3 different from the processor 3 to which task T8 is allocated.

<Step 8-3> Task T9 is present immediately after task T8, and task T9 is allocated to the processor 1 different from the processor 3 to which task T8 is allocated. It is thus determined whether the allocation destination of task T8 is to be changed.

<Step 8-4> It is estimated whether the inter-processor communication data amount of the entire program is decreased by changing the allocation destination of task T8 to the processor 1, 2.

<Step 8-5> An estimated required execution time in a case where task T8 is executed, without change, by the processor 3, and an estimated required execution time in a case where task T8 is executed by the candidate processor 1, 2 for allocation destination change, are calculated.

<Step 8-6> Assume that the result in step 8-4 shows that the inter-processor communication data amount of the entire program is unchanged even if the allocation destination of task T8 is changed to the processor 1 or 2. In addition, assume that the result in step 8-5 shows that the estimated required execution time is shortest if task T8 is executed, without change, on the processor 3.

<Step 8-7> Based on the result in step 8-6, it is determined that the allocation destination processor for task T8 is not changed.

[Optimization of Allocation Destination of Task T9]

<Step 9-1> Task T9 is read out.

<Step 9-2> Task T8 is present immediately before task T9. Task T8 is allocated to the processor 3 different from the processor 1 to which task T9 is allocated.

<Step 9-3> Since only a pseudo task is present immediately after task T9, it can be ignored. However, since task T8 immediately before task T9 is allocated to the processor 3 different from the processor 1 to which task T9 is allocated, it is determined whether the allocation destination of task T9 is to be changed.

<Step 9-4> It is estimated whether the inter-processor communication data amount of the entire program is decreased by changing the allocation destination of task T9 to the processor 3.

<Step 9-5> An estimated required execution time in a case where task T9 is executed, without change, by the processor 1, and an estimated required execution time in a case where task T9 is executed by the candidate processor 3 for allocation destination change, are calculated.

<Step 9-6> Assume that the result in step 9-4 shows that the inter-processor communication data amount of the entire program is decreased by changing the allocation destination of task T9 to the processor 1. In addition, assume that the result in step 9-5 shows that the estimated required execution time becomes shorter if task T9 is executed on the processor 3.

<Step 9-7> Based on the result in step 9-6, it is determined that the allocation destination processor for task T9 is changed to the processor 3.

As a result of the above task allocation process, the allocation of the tasks of the program (shown in FIG. 10) provisionally allocated as shown in FIG. 11 is optimized as shown in FIG. 12.

(Acquisition of Program Module for Allocation Destination Processor)

A description is given of a process of acquiring a program module for an allocation change destination processor in the optimization execution section (allocation destination processor changing section) 26 shown in FIG. 8.

In order to execute the task, whose allocation destination processor has been changed by the above-described process, it is necessary to acquire, by some method, a program module for the allocation destination processor. The program module necessary for executing the task whose allocation destination processor has been changed, is described by the instruction set possessed by the provisionally allocated processor. This instruction set is different from the instruction set possessed by the changed allocation destination processor.

In the present example, any one of the three procedures illustrated in FIGS. 17 to 19 is used to acquire the program module for executing the task and is described by the instruction set possessed by the changed allocation destination processor. FIGS. 17 to 19 illustrate in detail the process of step S13 in FIG. 13.

In the procedure shown in FIG. 17, the instructions peculiar to the instruction set possessed by the provisional allocation processor, which is used to describe the program module originally possessed by the object task, are replaced with instructions for executing the same process as with the instruction set of the changed allocation destination processor. Thereby, the program module described by the instruction set possessed by the changed allocation destination processor is obtained.

To start with, it is determined whether the instructions in the program module of the object task, whose allocation destination has been determined to be changed, are absent or not in the allocation destination processor (step S301). If “YES” in step S301, the instructions are replaced with instructions for executing the same process as with the instruction set of the allocation destination processor, thereby generating a program module for the allocation destination processor (step S302). If “NO” in step S301, there is no need to acquire a new program module, and the process is finished. The processing in steps S301 and S302 is repeated until the completion of the processing for all instructions is determined in step S303.

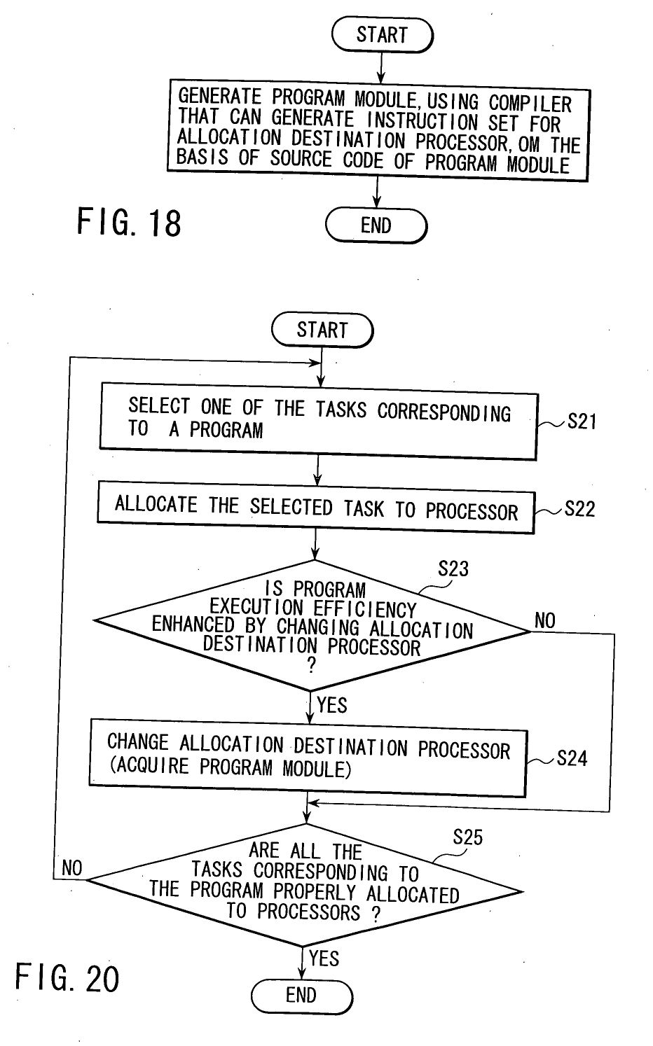

FIG. 18 illustrates a process substituted for step S302 in FIG. 17. The procedure of this process uses a compiler capable of generating a program module described by the instruction set possessed by the changed allocation destination processor, on the basis of the source code of the program module originally possessed by the object task. Thereby, the program module described by the instruction set possessed by the changed allocation destination processor is acquired.

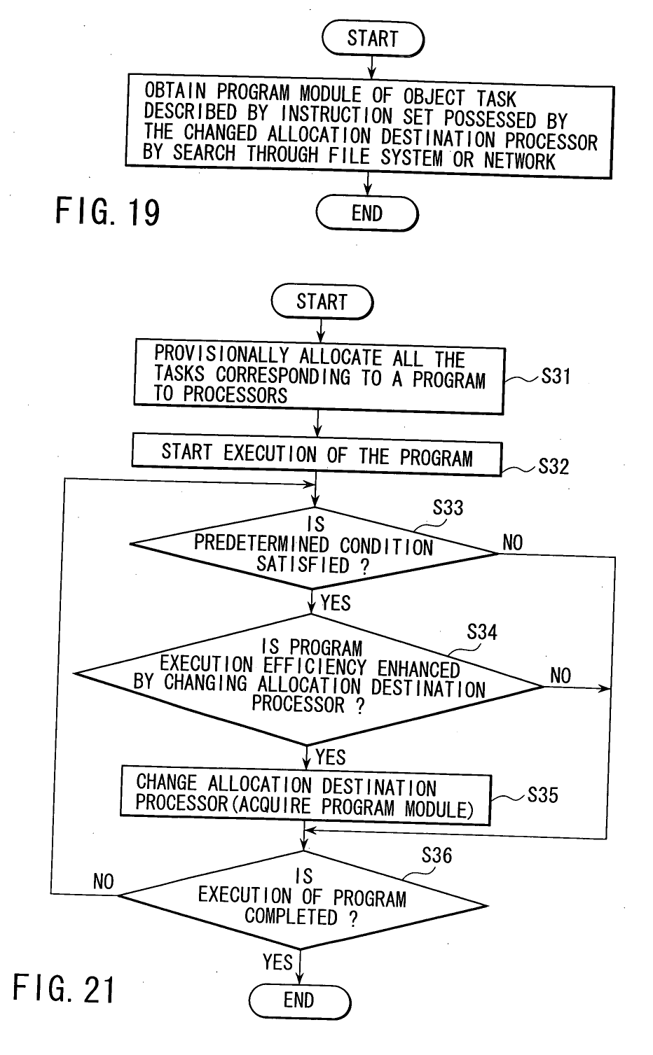

FIG. 19 also illustrates a process substituted for step S302 in FIG. 17. In the procedure of this process, the program module of the object task described by the instruction set possessed by the changed allocation destination processor is obtained by a search through the file system or the network.

(Task Allocation Process Procedure 2)

Next, another example of the task allocation process procedure is described. FIG. 20 illustrates the flow of task allocation process procedure 2.

In the task allocation process procedure 1 shown in FIG. 13, all tasks are provisionally allocated to the respective processors (step S11). It is determined whether the program execution efficiency is enhanced by changing the allocation destination processor (step S12). The allocation destination processor for the object task, which has been determined to enhance the program execution efficiency by the change of the allocation destination processor, is changed (step S13).

On the other hand, in the task allocation process procedure 2 shown in FIG. 20, one of the tasks is selected (step S21). The selected task is subjected to the processing corresponding to steps S11 to S13 in FIG. 13 (steps S22 to S24). The processing in steps S21 to S24 is repeated until the completion of the allocation process for allocating all tasks to the processors is determined.

If the process shown in FIG. 20 is completed, all the tasks of the program are properly allocated to the processors. Therefore, the multiprocessor system can efficiently execute the program.

(Task Allocation Process Procedure 3)

FIG. 21 illustrates the flow of still another task allocation process procedure. In this task allocation process procedure 3, all the tasks are provisionally allocated, as in step S11 in FIG. 13, following which the execution of the program is started (steps S31 and S32). Thereafter, only when a predetermined condition is satisfied in step S33 during the execution of the program, the processing corresponding to steps S12 and S13 in FIG. 13 is performed (steps S34 and S35). The processing in steps S33 to S35 is repeated until the completion of the execution of the program is determined in step S36.

Some examples of the “predetermined condition” in step S33 are as follows.

[Condition 1] An interrupt by the system timer, which comes at regular intervals, has occurred.

[Condition 2] A notice indicative of possible overload has been issued from a certain processor.

[Condition 3] An interrupt has occurred from a processor in an idle state.

[Condition 4] A notice has been issued from a certain processor that the certain processor has issued an input/output instruction and initiated an execution completion wait state for the input/output instruction.

[Condition 5] A certain processor has issued a notice to the effect that execution of one task is completed.

Examples other than Conditions 1 to 5 are possible.

(Program Module Complex)

Other embodiments of the present invention will now be described.

In the above-described embodiments, the program to be executed by the hetero-multiprocessor system is a program described based on the inter-task dependency. Moreover, each task, as shown in FIG. 10, is created based on only the program module described by the instruction set for a specific processor.

However, it is not necessary that each task of the program to be executed by the hetero-multiprocessor system is a single program module. Of all the tasks, at least one task may be created based on a complex including a plurality of program modules (hereinafter referred to as “program module complex”) described by instruction sets possessed by two or more kinds of processors.

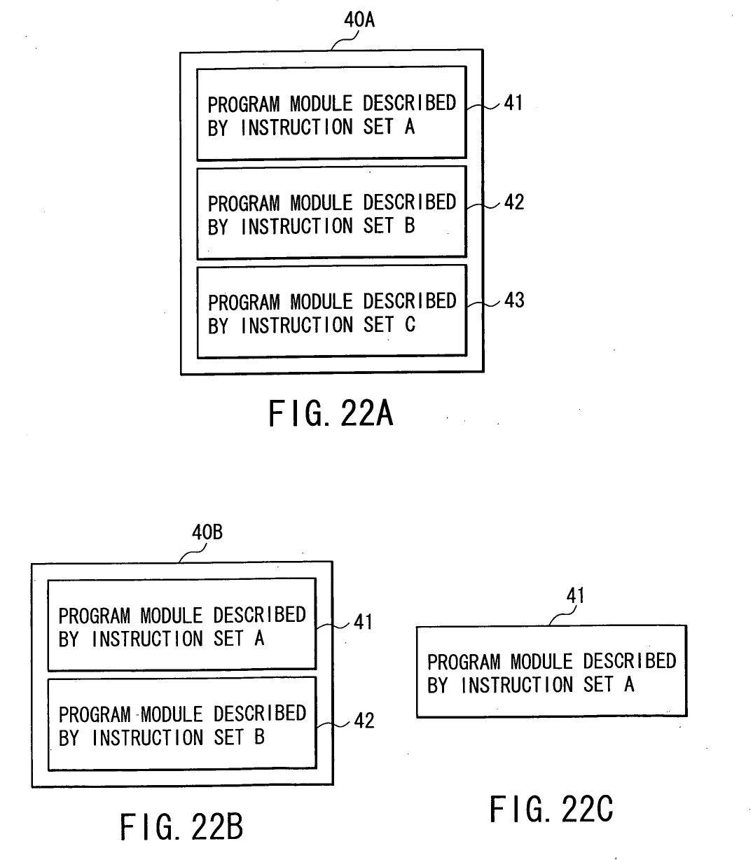

For example, a program module complex 40A shown in FIG. 22A includes program modules 41, 42, and 43 described by instruction sets A, B and C. A program module complex 40B shown in FIG. 22B includes program modules 41 and 42 described by instruction sets A and B.

Each of the tasks of the program is given as a program module complex shown in FIG. 22A or 22B, or as a single program module 41 shown in FIG. 22C, depending on, e.g. the content of the task or the intention of the creator of the task.

All the tasks of the program may be given as program module complexes each including a plurality of program modules described by a plurality of common instruction sets. In other words, each of the tasks may be created based on a program module complex, for example, as shown in FIG. 22A.

In the case where the above-described structure of the program module complex is applied to the task, it is preferable to set, as a prerequisite standard, a determination standard “a program module described by an instruction set possessed by an allocation destination processor is present in a program module complex of the object task”, in addition to the aforementioned execution efficiency determination standards. The reason is that unless the program module described by the instruction set possessed by the candidate processor for allocation destination change is present in the program module complex of the object task, the object task cannot be executed on the changed allocation destination processor even if the allocation destination processor is changed.

Next, a description is given of the processing in steps S11 and S13 in FIG. 13 in the case where at least one of the tasks is created based on the above-described program module complex.

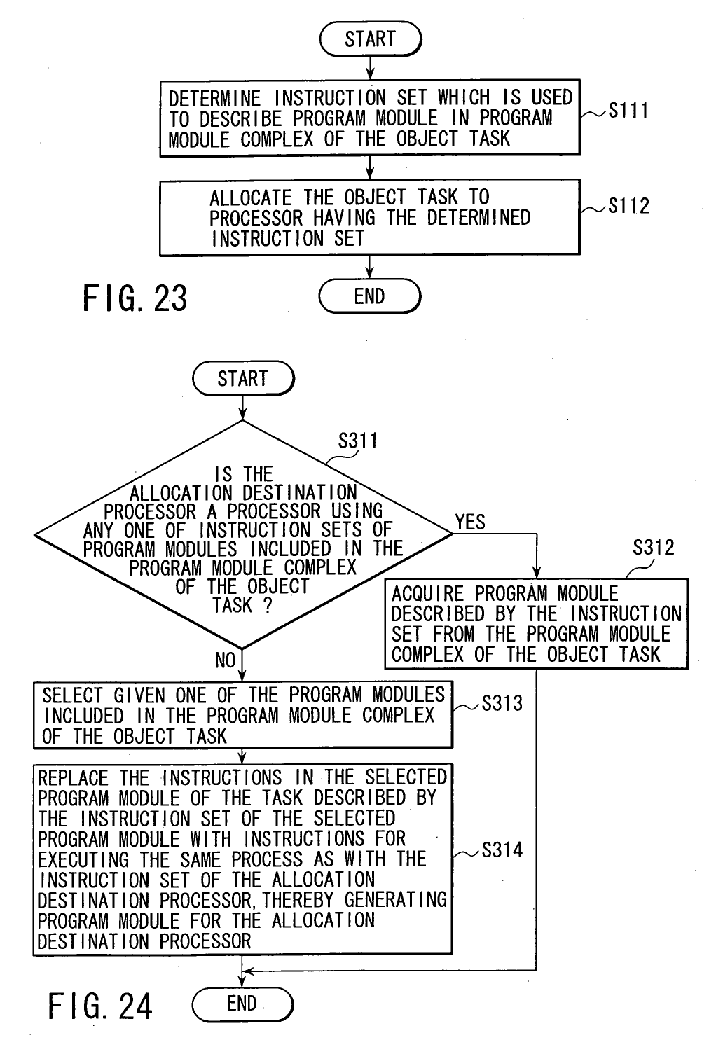

FIG. 23 illustrates in detail the process corresponding to step S11 in FIG. 13. The instruction set, which is used to describe the program module in the program module complex of the object task to be allocated, is determined (step S111). The object task is allocated to the processor having the determined instruction set (step S112).

Some examples of the process procedure corresponding to step S13 in FIG. 13 are described with reference to FIGS. 24 to 26.

In the process procedure shown in FIG. 24, it is determined whether the allocation destination processor determined in step S12 in FIG. 13 is a processor using any one of the instruction sets of the program modules included in the program module complex of the object task (step S311). If “YES” in step S311, the program module described by the instruction set is acquired from the program module complex (step S312).

On the other hand, if “NO” in step S311, a given one of the program modules included in the program module complex of the object task is selected (step S313). Then, like step S302 in FIG. 17, the instructions in the program module of the task described by the instruction set selected in step S313 are replaced with instructions for executing the same process as with the instruction set of the allocation destination processor, thereby generating a program module for the allocation destination processor (step S314).

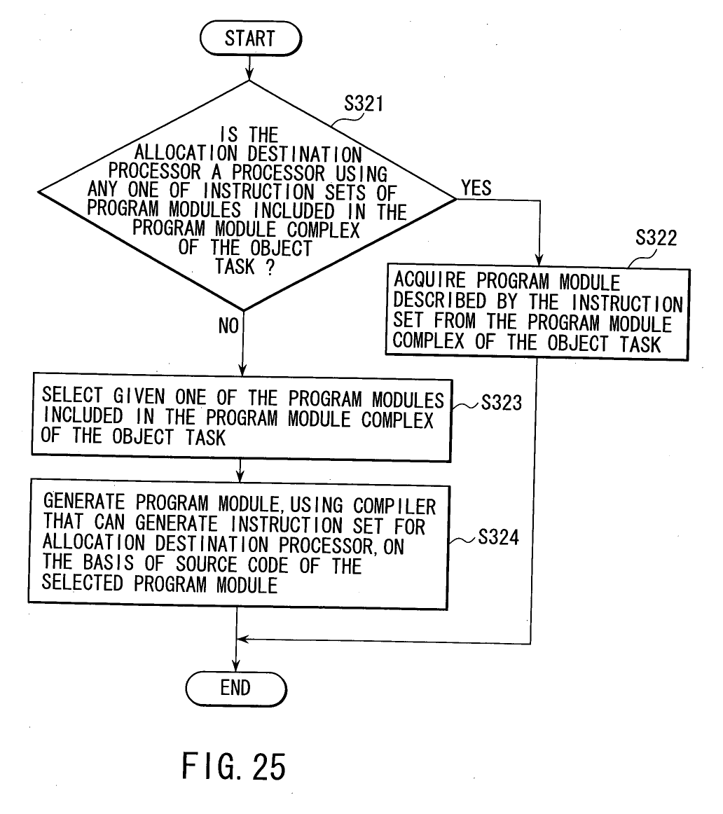

In the process procedure in FIG. 25, the processing in steps S321 to S323 is the same as the processing in steps S311 to S313. The processing in step S324 alone is different. If “NO” in step S321, a given one of the program modules included in the program module complex of the object task is selected (step S323).

Like the process shown in FIG. 18, a compiler is used which is capable of generating a program module described by the instruction set possessed by the changed allocation destination processor, on the basis of the source code of the program module selected in step S323. Thereby, the program module described by the instruction set possessed by the changed allocation destination processor is acquired.

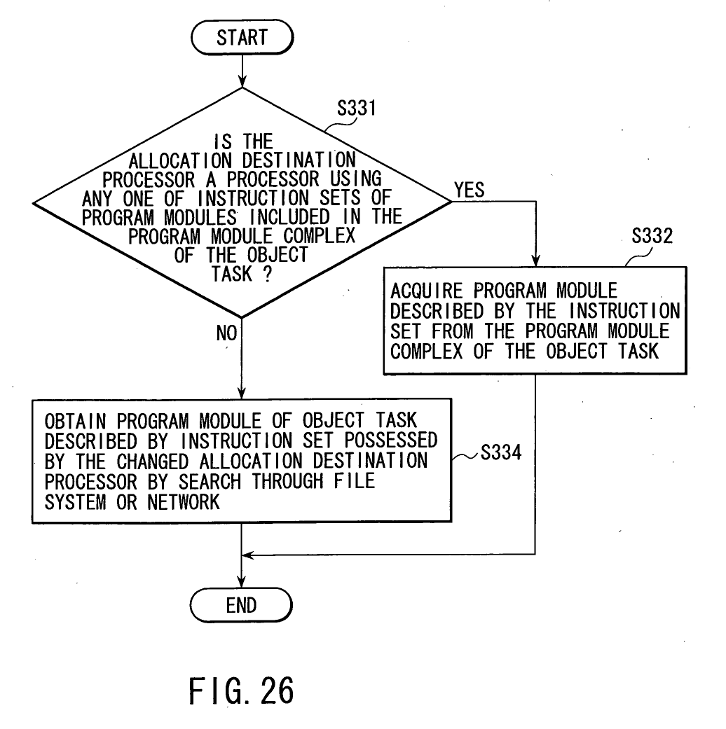

In the process procedure in FIG. 26, the processing in steps S331 and S332 is the same as the processing in steps S311 and S312. The processing in step S334 alone is different. If “NO” in step S331, the control advances to step S334, and the program module of the object task described by the instruction set possessed by the changed allocation destination processor is obtained by a search through the file system or the network.

As has been described above, even in the case where a task is created based on the program module complex, the task allocation according to embodiments of the present invention is effective.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A task allocation method of allocating a task selectively to a first processor and a second processor in a multiprocessor system, the first processor having a first instruction set and the second processor a second instruction set, and the task corresponding to a program having an execution efficiency, the method comprising:
allocating a task corresponding to a program module described by the first instruction set to the first processor;
determining whether or not the execution efficiency of the program is improved if a destination allocated for the task is changed from the first processor to the second processor; and
changing the destination allocated for the task to the second processor if the execution efficiency of the program is improved.

2. The method according to claim 1, further comprising:
estimating a first execution time of the program in a case where the task is allocated to the first processor and estimating a second execution time of the program in a case where the task is allocated to the second processor; and
determining whether the second execution time is shorter than the first execution time, in order to determine whether or not the execution efficiency of the program is improved.

3. The method according to claim 1, further comprising:
estimating a first data amount processible by the task within a unit time in a case where the task is allocated to the first processor and estimating a second data amount processible by the task within a unit time in a case where the task is allocated to the second processor; and
determining whether the second data amount is larger than the first data amount, in order to determine whether or not the execution efficiency of the program is improved.

4. The method according to claim 1, further comprising:
estimating a first data amount processible by the task within a unit time in a case where the task is allocated to the first processor and estimating a second data amount processible by the task within a unit time in a case where the task is allocated to the second processor;
estimating an increment of data amount between the first data amount and the second data amount; and
determining whether the increment is larger than a preset threshold, in order to determine whether or not the execution efficiency of the program is improved.

5. The method according to claim 1, further comprising:
estimating a load on of the second processor in a case where the destination allocated for the task is changed from the first processor to the second processor;
determining whether the load on the second processor is an overload, in order to determine whether or not the execution efficiency of the program is improved.

6. The method according to claim 1, further comprising:
estimating a first amount of data transferred by inter-processor communication in the program in a case where the task is allocated to the first processor and estimating a second amount of data transferred by inter-processor communication in the program in a case where the task is allocated to the second processor; and
determining whether the second amount of data is smaller than the first amount of data, in order to determine whether or not the execution efficiency of the program is improved.

7. The method according to claim 1, further comprising:
estimating a first amount of data transferred by inter-processor communication within a unit time in the program in a case where the task is allocated to the first processor and estimating a second amount of data transferred by inter-processor communication within a unit time in the program in a case where the task is allocated to the second processor; and
determining whether the second amount of data within the unit time is smaller than the first amount of data within the unit time, in order to determine whether or not the execution efficiency of the program is improved.

8. The method according to claim 1, further comprising:
acquiring a program module described by the second instruction set, which is necessary for creating a task to be allocated to the second processor, by replacing a first instruction, in the program module described by the first instruction set, with a second instruction of the second instruction set, for executing the same process as the first instruction.

9. The method according to claim 1, further comprising:
acquiring a program module described by the second instruction set, which is necessary for creating a task to be allocated to the second processor, by compiling a source code for the program module described by the first instruction set with a compiler for the second processor.

10. The method according to claim 1, further comprising:
acquiring a program module described by the second instruction set from a file system or a network.

11. The method according to claim 1, wherein the program module is a program module complex including a first program module described by the first instruction set for the first processor and a second program module described by the second instruction set for the second processor, and wherein said task is created by using one of the first program module and the second program module.

12. The method according to claim 1, further comprising:
updating a task allocation table storing task allocation information, in response to the changing of the destination allocated for the task to the second processor.

13. A multiprocessor system having a first processor with a first instruction set and a second processor with a second instruction set, the system comprising:
a task allocation unit configured to allocate a task that corresponds to a program including a program module described by the first instruction set to the first processor, the program having an execution efficiency;
a determination unit configured to determine whether or not the execution efficiency of the program is improved if a destination allocated for the task is changed from the first processor to the second processor; and
a task allocation control unit configured to change the destination allocated for the task to the second processor if the execution efficiency of the program is improved.

14. The system according to claim 13, further comprising:
an estimation unit configured to estimate a first execution time of the program in a case where the task is allocated to the first processor and to estimate a second execution time of the program in a case where the task is allocated to the second processor; and
a determination unit configured to determine whether the second execution time is shorter than the first execution time, in order to determine whether or not the execution efficiency of the program is improved.

15. The system according to claim 13, further comprising:
an estimation unit configured to estimate a first data amount processible by the task within a unit time in a case where the task is allocated to the first processor and to estimate a second data amount processible by the task within a unit time in a case where the task is allocated to the second processor; and
a determination unit configured to determine whether the second data amount is larger than the first data amount, in order to determine whether or not the execution efficiency of the program is improved.

16. The system according to claim 13, further comprising:
an estimation unit configured to estimate a first data amount processible by the task within a unit time in a case where the task is allocated to the first processor and to estimate a second data amount processible by the task within a unit time in a case where the task is allocated to the second processor, thereby estimating an increment of data amount between the first data amount and the second data amount; and
a determination unit configured to determine whether the increment of data amount is larger than a preset threshold, in order to determine whether or not the execution efficiency of the program is improved.

17. The system according to claim 13, further comprising:
an estimation unit configured to estimate a load on of the second processor in a case where the destination allocated for the task is changed from the first processor to the second processor;
a determination unit configured to determine whether the load on the second processor is an overload, in order to determine whether or not the execution efficiency of the program is improved.

18. The system according to claim 13, further comprising:
an estimation unit configured to estimate a first amount of data transferred by inter-processor communication in the program in a case where the task is allocated to the first processor and to estimate a second amount of data transferred by inter-processor communication in the program in a case where the task is allocated to the second processor; and
a determination unit configured to determine whether the second amount of data is smaller than the first amount of data, in order to determine whether or not the execution efficiency of the program is improved.

19. The system according to claim 13, further comprising:
an estimation unit configured to estimate a first amount of data transferred by inter-processor communication within a unit time in the program in a case where the task is allocated to the first processor and to estimate a second amount of data transferred by inter-processor communication within a unit time in the program in a case where the task is allocated to the second processor; and
a determination unit configured to determine whether the second amount of data within the unit time is smaller than the first amount of data within the unit time, in order to determine whether or not the execution efficiency of the program is improved.

20. The system according to claim 13, further comprising:
an acquisition unit configured to acquire a program module described by the second instruction set, which is necessary for creating a task to be allocated to the second processor, by replacing a first instruction, in the program module described by the first instruction set, with a second instruction of the second instruction set, for executing the same process as the first instruction.

21. The system according to claim 13, further comprising:
an acquisition unit configured to acquire a program module described by the second instruction set, which is necessary for creating a task to be allocated to the second processor, by compiling a source code for the program module described by the first instruction set with a compiler for the second processor.

22. The system according to claim 13, further comprising:
an acquisition unit configured to acquire a program module described by the second instruction set from a file system or a network.

23. The system according to claim 13, wherein the program module is a program module complex including a first program module described by the first instruction set for the first processor and a second program module described by the second instruction set for the second processor, and wherein said task is created by using one of the first program module and the second program module.

24. The system according to claim 13, further comprising:
a task allocation table storing task allocation information, in response to the changing of the destination allocated for the task to the second processor.

25. A program product comprising a computer usable medium having computer readable program code means for causing a multiprocessor system having a first processor with a first instruction set and a second processor with a second instruction set, to allocate a task to either of the first processor or the second processor, the task corresponding to a program having an execution efficiency, the program including a program module described by either of the first instruction set or the second instruction set, the computer readable program code means in the computer program product comprising:
program code means for causing the multiprocessor system to allocate a task that corresponds to a program module described by the first instruction set to the first processor;
program code means for causing the multiprocessor system to determine whether or not the execution efficiency of the program is improved if a destination allocated for the task is changed from the first processor to the second processor; and
program code means for causing the multiprocessor system to change the destination allocated for the task to the second processor if the execution efficiency of the program is improved.
